(19) United States
(12) Patent Application Publication
(10) Pub. No.: US 2012/0050245 A1
(43) Pub. Date: Mar. 1, 2012

(54) CHARGE SHARING SYSTEM AND METHOD OF LCOS DISPLAY

(75) Inventors: Yongping Dai, Guangdong (CN); Xuhuai Dong, Guangdong (CN); Wei Fan, Guangdong (CN); Yi Fan, Guangdong (CN)

(73) Assignee: SHENZHEN YANGTZE LIVE CO., LTD., Shenzhen, Guangdong (CN)

(21) Appl. No.: 13/265,447

(22) PCT Filed: Sep. 16, 2010
(86) PCT No.: PCT/CN2010/076990

§ 371 Date: Oct. 20, 2011

(30) Foreign Application Priority Data
Jul. 13, 2010 (CN) 201010224997.0

(51) Int. Cl. G09G 3/36; G06F 3/038

(52) U.S. Cl. 345/211; 345/90

(57) ABSTRACT

In the field of a liquid crystal on silicon (LCoS) display, a charge sharing system and a charge sharing method of an LCoS display are provided. The system includes: a column driving circuit, a row driving circuit, a pixel matrix, a control circuit, a gamma reference voltage circuit, and a first switching module. The column driving circuit includes a second switching module, a buffer, a shift register, a latch, and a digital-to-analog (D/A) converter. The second switching module is serially connected between the D/A converter and the buffer. The control circuit simultaneously outputs a signal for controlling turn-off of the buffer, a signal for controlling turn-off of a switch in the second switching module, and a signal for controlling turn-off of the gamma reference voltage circuit. The control circuit outputs a signal for controlling turn-on of a switch in the first switching module. The control circuit outputs a signal for controlling the row driving circuit. The control circuit simultaneously outputs a signal for controlling turn-on of the buffer, a signal for controlling turn-on of the switch in the second switching module, and a signal for controlling turn-on of the gamma reference voltage circuit.

### BACKGROUND

1. Technical Field

The present invention relates to the field of a liquid crystal on silicon (LCoS) display, and more particularly to a charge sharing system and a charge sharing method of an LCoS display.

2. Related Art

A charge sharing system of a liquid crystal on silicon (LCoS) display is applied to improve the charge use efficiency of the display, and reduce the power consumption of an LCoS display system. A charge recycling circuit of a conventional liquid crystal display (LCD) driving circuit system is shown in FIG. 1. According to the point overturn driving principle, the driving voltages of adjacent pixel points have opposite polarities. By using the characteristic, two adjacent column drive lines serve as a charge recycling pair. Before the driving voltage of a next row is loaded, the column driving circuit and pixel electrodes are first disconnected, and the two adjacent column drive lines are short-connected, so that due to their opposite polarities, a part of the voltage is neutralized. Therefore, the voltage amplitude of the column driving circuit for charging/discharging the pixel storage capacitor is reduced, and the dynamic power consumption is lowered accordingly. When data of adjacent pixels is the same, the voltage may well be neutralized, and in this case, the dynamic power consumption may be reduced by 50%. However, in most cases, the LCD displays color images, that is, adjacent sub-pixel points display different data, which leads to varied voltage amplitudes between adjacent pixels R₁ and G₁, B₁ and R₂, and G₂ and B₂, so that the voltage fails to be sufficiently neutralized, and the reduced dynamic power consumption is less than 50%.

To eliminate the defect of insufficient voltage neutralization, a design scheme of a charge recycling circuit as shown in FIG. 2 is provided in the prior art. Two adjacent pixels serve as a charge recycling pair. Before the driving voltage of a next row is loaded, the column driving circuit and the pixel electrodes are first disconnected, and drive lines of two adjacent pixels (Rₖ, Gₖ, Bₖ) and (Rₖ₊₁, Gₖ₊₁, Bₖ₊₁) are short-connected, that is, Rₖ and Rₖ₊₁, Gₖ and Gₖ₊₁, and Bₖ and Bₖ₊₁ are respectively short-connected, where k=1, 2, . . . , N−1, and N is the number of the sub-pixels. The voltage of all the sub-pixel points is neutralized to V_{com} (V_{com}=V_{H}/2+V_{L}/2, where V_{H} is a high driving voltage, and V_{L} is a low driving voltage), so as to reduce the dynamic power consumption by 50%.

In the implementation of the present invention, the inventor finds that the prior art at least has the following disadvantage.

The charge sharing system and the charge sharing method in the prior art can only save 50% of the dynamic power consumption which is quite low, and fails to reduce the static power consumption of the column driving circuit and the display system.

### SUMMARY

In order to further reduce the dynamic power consumption of the LCoS driving circuit system, and lower the static power consumption of the column driving circuit and the display system, the present invention provides a charge sharing system and a charge sharing method of an LCoS display.

The charge sharing system of an LCoS display includes: a column driving circuit, a row driving circuit, a pixel matrix, a control circuit, a gamma reference voltage circuit, and a first switching module. The column driving circuit includes a second switching module, a buffer, a shift register, a latch, and a digital-to-analog (D/A) converter. The second switching module is serially connected between the D/A converter and the buffer.

The control circuit is used for simultaneously outputting a signal for controlling turn-off of the buffer, a signal for controlling turn-off of a switch in the second switching module, and a signal for controlling turn-off of the gamma reference voltage circuit.

The control circuit is used for outputting a signal for controlling turn-on of a switch in the first switching module, so as to implement short connection between two adjacent pixels in the pixel array. The control circuit is used for outputting a signal for controlling the row driving circuit, so as to implement charging of an i^{th} row pixel storage capacitor by an (i+1)^{th} row pixel storage capacitor on the same column in the pixel array, where i=1, 2, . . . , M−1, and M is the number of rows of the pixels.

The control circuit is used for simultaneously outputting a signal for controlling turn-on of the buffer, a signal for controlling turn-on of the switch in the second switching module, and a signal for controlling turn-on of the gamma reference voltage circuit, so as to implement charging of the storage capacitors in the pixel matrix by the column driving circuit.

When the column driving circuit does not charge the storage capacitors in the pixel matrix, the control circuit sends a signal for controlling turn-off of the buffer and the gamma reference voltage circuit.

The charge sharing method of an LCoS display includes the following steps.

(1) A control circuit simultaneously outputs a signal for controlling turn-off of a buffer, a signal for controlling turn-off of a switch in a second switching module, and a signal for controlling turn-off of a gamma reference voltage circuit.

(2) After an i^{th} row scanning signal arrives, the control circuit outputs a signal for controlling turn-on of a switch in a first switching module, so as to implement short connection between two adjacent pixels on the same row in the pixel array, where i=1, 2, . . . , M−1, and M is the number of rows of the pixels.

(3) After the short connection between the two adjacent pixels on the same row in the pixel array is implemented, the switch in the first switching module is turned off, and the control circuit outputs a signal for controlling a row driving circuit, so as to implement charging of an i^{th} row pixel storage capacitor by an (i+1)^{th} row pixel storage capacitor on the same column in the pixel array.

(4) The control circuit simultaneously outputs a signal for controlling turn-on of the buffer, a signal for controlling turn-on of the switch in the second switching module, and a signal for controlling turn-on of the gamma reference voltage circuit, so as to implement charging of the i^{th} row storage capacitor in the pixel matrix by the column driving circuit. When all the pixel storage capacitors in the pixel matrix are charged, the process ends; otherwise, Steps (1) to (4) are repeated.

The control circuit outputting the signal for controlling the row driving circuit, so as to implement the charging of the i^{th} row pixel storage capacitor by the (i+1)^{th} row pixel storage capacitor on the same column in the pixel array in Step (3) specifically includes the following content.

The control circuit outputs a signal for controlling the row driving circuit, and loads a scanning pulse to (i+1)^{th} row pixels, so as to implement short connection between the pixel storage capacitors on the same column of the i^{th} row and the (i+1)^{th} row, so as to implement the charging of the i^{th} row pixel storage capacitor by the (i+1)^{th} row pixel storage capacitor on the same column.

The technical solutions of the present invention have the following beneficial effects.

Through the charge sharing system and the charge sharing method, the dynamic power consumption is reduced by 75%. Meanwhile, the control circuit controls the turn-off and the turn-on of the buffer and the gamma reference voltage circuit, so that the static power consumption of the column driving circuit and the display system is reduced, the charge use efficiency of the display is improved, and the power consumption of the LCoS display system is lowered.

The present invention will be further illustrated below with embodiments and the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a diagram of a charge recycling circuit of an LCD driving circuit system in the prior art;

FIG. 2 is a diagram of the charge recycling circuit of the LCD driving circuit system in the prior art;

FIG. 3 is a circuit diagram of a charge sharing system of an LCoS display according to the present invention; and

FIG. 4 is a flow chart of a charge sharing method of an LCoS display according to the present invention.

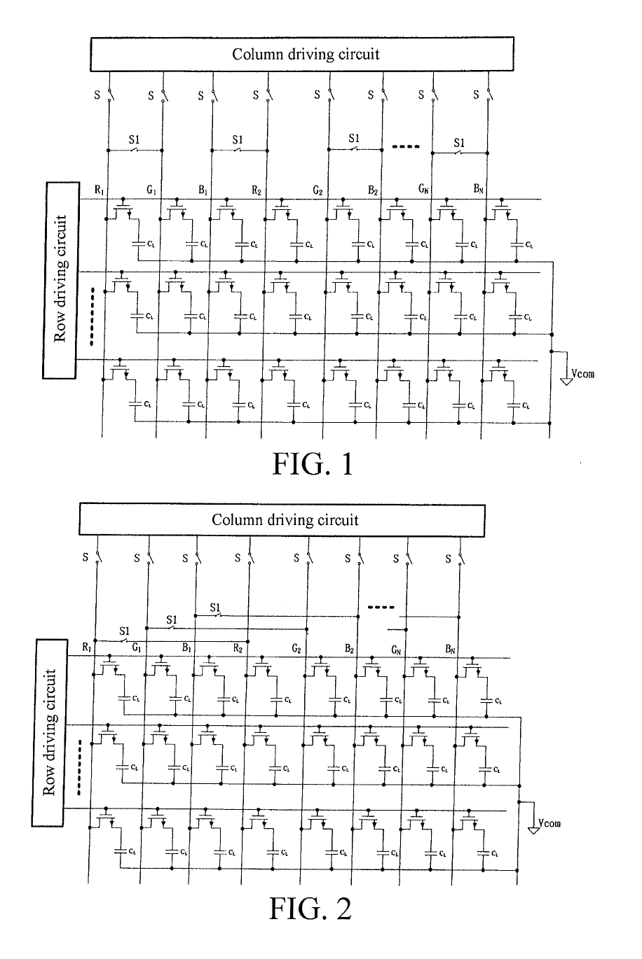

In the drawings, the reference numerals respectively represent the following components:
1: column driving circuit; 2: row driving circuit; 3: pixel matrix; 4: control circuit; 5: first switching module; 6: gamma reference voltage circuit; 11: second switching module; 12: buffer; 13: shift register; 14: latch; and 15: D/A converter.

### DETAILED DESCRIPTION

In order to make the objectives, technical solutions, and advantages of the present invention more comprehensible, the present invention is further described in detail below with reference to embodiments and the accompanying drawings.

### Embodiment 1

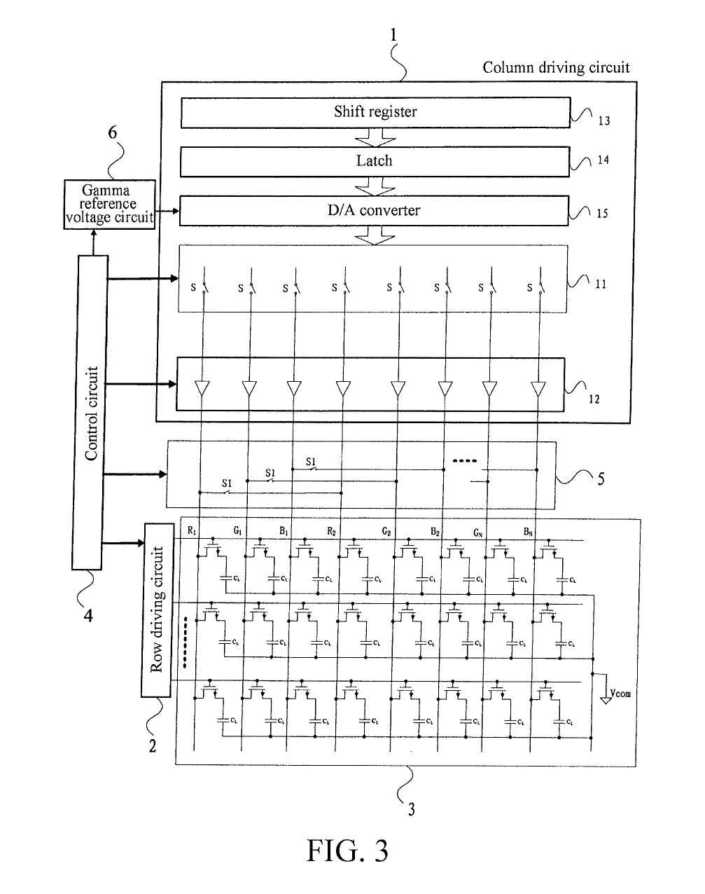

In order to further reduce the dynamic power consumption of the LCoS driving circuit system, and lower the static power consumption of the column driving circuit and the display system, the present invention provides a charge sharing system of an LCoS display, and the details are described in the following with reference to FIG. 3.

The spatial correlation of LCD display refers to that the colors of two adjacent pixels are identical or close. As the colors of most areas in an image change gradually, the colors of two adjacent pixels are close or identical in most cases. Therefore, sub-pixels having the same color attribute in the two adjacent pixels (each pixel consists of three consecutive sub-pixels) have the same voltage amplitude but opposite polarities. The temporal correlation of the LCD display refers to that displayed images of two consecutive frames are identical or close, so that the sub-pixels having the same color attribute in the two pixels have the same voltage amplitude but opposite polarities.

The charge sharing system of an LCoS display in the present invention includes: a column driving circuit 1, a row driving circuit 2, a pixel matrix 3, a control circuit 4, a first switching module 5, and a gamma reference voltage circuit 6. The column driving circuit 1 includes: a second switching module 11, a buffer 12, a shift register 13, a latch 14, and a D/A converter 15. The second switching module 11 is serially connected between the D/A converter 15 and the buffer 12.

The control circuit 4 is used for simultaneously outputting a signal for controlling turn-off of the buffer 12, a signal for controlling turn-off of a switch in the second switching module 11, and a signal for controlling turn-off of the gamma reference voltage circuit 6.

The control circuit 4 is used for outputting a signal for controlling turn-on of a switch in the first switching module 5, so as to implement short connection between two adjacent pixels in the pixel array 3. The control circuit 4 is used for outputting a signal for controlling the row driving circuit 2, so as to implement charging of an i^{th} row pixel storage capacitor by an (i+1)^{th} row pixel storage capacitor on the same column in the pixel array 3, where i=1, 2, . . . , M−1, and M is the number of rows of the pixels.

The control circuit 4 is used for simultaneously outputting a signal for controlling turn-on of the buffer 12, a signal for controlling turn-on of the switch in the second switching module 11, and a signal for controlling turn-on of the gamma reference voltage circuit 6, so as to implement charging of the storage capacitors in the pixel matrix 3 by the column driving circuit 1 when the buffer 12, the gamma reference voltage circuit 6, and the switch in the second switching module 11 are turned on.

Further, when the column driving circuit 1 does not charge the storage capacitors in the pixel matrix 3, the control circuit 4 sends a signal for controlling turn-off of the buffer 12 and the gamma reference voltage circuit 6.

Furthermore, the charge system is not only applicable to an LCoS color display system and an LCoS monochrome display system, but also applicable to a thin film transistor-liquid crystal display (TFT-LCD) color display system and a TFT-LCD monochrome display system.

Through the above charge system, the voltage of all the sub-pixels in the pixel matrix 3 is changed into V_{H}/4+3V_{L}/4 or V_{L}/4+3V_{H}/4, that is, the dynamic power consumption is reduced by 75%. Meanwhile, the control circuit 4 controls the turn-off and the turn-on of the buffer 12 and the gamma reference voltage circuit 6, so that the static power consumption of the column driving circuit 1 and the display system is reduced, the charge use efficiency of the display is improved, and the power consumption of the LCoS display system is lowered.

The specific operating process is described below with reference to FIG. 3.

The control circuit 4 simultaneously outputs a signal for controlling turn-off of the buffer 12, a signal for controlling turn-off of the switch in the second switching module 11, and a signal for controlling turn-off of the gamma reference voltage circuit 6. After an i^{th} row scanning signal arrives, the control circuit 4 outputs a signal for controlling turn-on of the switch in the first switching module 5, so as to implement short connection between two adjacent pixels in the pixel array 3, and the short connection may last for a short period of time. After the short connection is implemented, the switch in the first switching module 5 is turned off. The control circuit 4 outputs a signal for controlling the row driving circuit 2, so as to implement charging of the i^{th} row pixel storage capacitor by the (i+1)^{th} row pixel storage capacitor on the same column in the pixel array 3. The control circuit 4 simultaneously outputs a signal for controlling turn-on of the buffer 12, a signal for controlling turn-on of the switch in the second switching module 11, and a signal for controlling turn-on of the gamma reference voltage circuit 6, so as to implement charging of the i^{th} row storage capacitor in the pixel matrix 3 by the column driving circuit 1 when the buffer 12, the gamma reference voltage circuit 6, and the switch in the second switching module 11 are turned on. Specifically, the switch in the first switching module 5 is turned on, and the storage capacitors of two adjacent pixels (Rₖ, Gₖ, Bₖ) and (Rₖ₊₁, Gₖ₊₁, Bₖ₊₁) are short-connected, that is, the storage capacitors of the three sub-pixels Rₖ and Rₖ₊₁, Gₖ and Gₖ₊₁ and Bₖ and Bₖ₊₁ are respectively short-connected, where k=1, 2, . . . , N−1, and N is the number of the sub-pixels. The control circuit 4 outputs a signal for controlling the row driving circuit 2, and loads a short-time scanning pulse to the (i+1)^{th} row pixels next to the i^{th} row, so as to implement short connection between the pixel storage capacitors on the same column of the i^{th} row and the (i+1)^{th} row, and to implement charging of the i^{th} row pixel storage capacitor by the (i+1)^{th} row pixel storage capacitor on the same column, where i=1, 2, . . . , M−1, and M is the number of rows of the pixels. Likewise, each row is charged by the next row, and the process is implemented till the last row is charged.

In view of the above, through the improved charge sharing system of an LCoS display provided in the embodiment of the present invention, the dynamic power consumption is reduced by 75%. Meanwhile, the control circuit controls the turn-off and the turn-on of the buffer and the gamma reference voltage circuit, so that the static power consumption of the column driving circuit and the display system is reduced, the charge use efficiency of the display is improved, and the power consumption of the LCoS display system is lowered.

### Embodiment 2

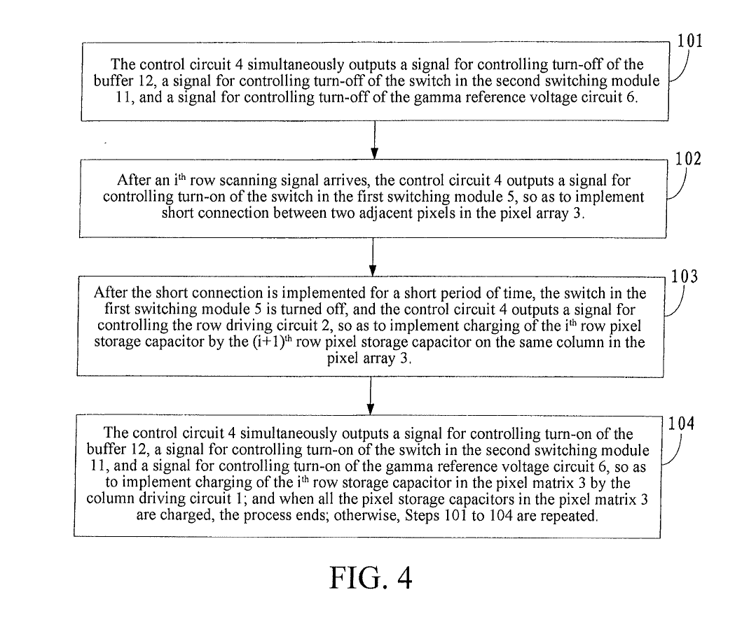

In order to further reduce the dynamic power consumption of the LCoS driving circuit system, and lower the static power consumption of the column driving circuit and the display system, the present invention provides a charge sharing method of an LCoS display, and the details are described in the following with reference to FIG. 3 and FIG. 4.

101: The control circuit 4 simultaneously outputs a signal for controlling turn-off of the buffer 12, a signal for controlling turn-off of the switch in the second switching module 11, and a signal for controlling turn-off of the gamma reference voltage circuit 6.

Specifically, when the LCoS displays a dynamic image, after the previous driving process is completed, the control circuit 4 outputs a signal for controlling turn-off of the switch in the second switching module 11 of the column driving circuit 1, so that the column driving circuit 1 and the pixel matrix 3 are disconnected, and simultaneously outputs a signal for controlling turn-off of the buffer 12 and the gamma reference voltage circuit 6.

102: After an i^{th} row scanning signal arrives, the control circuit 4 outputs a signal for controlling turn-on of the switch in the first switching module 5, so as to implement short connection between two adjacent pixels in the pixel array 3, where i=1, 2, . . . , M−1, and M is the number of rows of the pixels.

Specifically, the storage capacitors of two adjacent pixels (Rₖ, Gₖ, Bₖ) and (Rₖ₊₁, Gₖ₊₁, Bₖ₊₁) are short-connected, that is, the storage capacitors of the three sub-pixels Rₖ and Rₖ₊₁, Gₖ and Gₖ₊₁, and Bₖ and Bₖ₊₁ in the two pixels (Rₖ, Gₖ, Bₖ) and (Rₖ₊₁, Gₖ₊₁, Bₖ₊₁) are respectively short-connected, where k=1, 2, . . . , N−1, and N is the number of the sub-pixels.

103: After the short connection is implemented for a short period of time, the switch in the first switching module 5 is turned off, and the control circuit 4 outputs a signal for controlling the row driving circuit 2, so as to implement charging of the i^{th} row pixel storage capacitor by the (i+1)^{th} row pixel storage capacitor on the same column in the pixel array 3.

Specifically, the control circuit 4 outputs a signal for controlling the row driving circuit 2, and loads a short-time scanning pulse to the (i+1)^{th} row pixels, so as to implement short connection between the pixel storage capacitors on the same column of the i^{th} row and the (i+1)^{th} row, so as to implement charging of the i^{th} row pixel storage capacitor by the (i+1)^{th} row pixel storage capacitor on the same column, where i=1, 2, . . . , M−1, and M is the number of rows of the pixels.

104: The control circuit 4 simultaneously outputs a signal for controlling turn-on of the buffer 12, a signal for controlling turn-on of the switch in the second switching module 11, and a signal for controlling turn-on of the gamma reference voltage circuit 6, so as to implement charging of the i^{th} row storage capacitor in the pixel matrix 3 by the column driving circuit 1. When all the pixel storage capacitors in the pixel matrix 3 are charged, the process ends; otherwise, Steps 101 to 104 are repeated.

Specifically, the control circuit 4 simultaneously outputs a signal for controlling turn-on of the buffer 12, a signal for controlling turn-on of the switch in the second switching module 11, and a signal for controlling turn-on of the gamma reference voltage circuit 6, and the column driving circuit 1 and the pixel matrix 3 are connected, so as to implement charging of the i^{th} row storage capacitor in the pixel matrix 3 by the column driving circuit 1, thereby completing scanning of the i^{th} row. When all the pixel storage capacitors in the pixel matrix 3 are charged, the process ends; otherwise, Steps 101 to 104 are repeated. Likewise, each row is charged by the next row, and the process is implemented till the last row is charged.

It can be known from the calculation method in the prior art that, through the above method, the voltage of all the sub-pixels in the pixel matrix 3 is changed into V_{H}/4+3V_{L}/4 or V_{L}/4+3V_{H}/4, that is, the dynamic power consumption is reduced by 75%. Meanwhile, the control circuit 4 controls the turn-off and the turn-on of the buffer 12 and the gamma reference voltage circuit 6, so that the static power consumption of the column driving circuit 1 and the display system is reduced, the charge use efficiency of the display is improved, and the power consumption of the LCoS display system is lowered.

In the actual implementation, the method may also be applied to a TFT-LCD display system.

In view of the above, through the improved charge sharing method of an LCoS display provided in the embodiment of the present invention, the dynamic power consumption is reduced by 75%. Meanwhile, the control circuit controls the turn-off and the turn-on of the buffer and the gamma reference voltage circuit, so that the static power consumption of the column driving circuit and the display system is reduced, the charge use efficiency of the display is improved, and the power consumption of the LCoS display system is lowered.

Persons skilled in the art may understand that the accompanying drawings are merely schematic views for illustrating an exemplary embodiment, and the serial numbers of the embodiments of the present invention are for illustration only, instead of indicating the preference of the embodiments.

Although the invention being described as some preferred embodiments, the scope for which the protection is sought by the present invention is not limited thereby. Various modifications and variations without departing from the scope or spirit of the invention should be considered falling within the scope of the present invention.

What is claimed is:

1. A charge sharing system of a liquid crystal on silicon (LCoS) display, comprising a column driving circuit, a row driving circuit, and a pixel matrix, wherein the system further comprises: a control circuit, a gamma reference voltage circuit, and a first switching module; the column driving circuit comprises a second switching module, a buffer, a shift register, a latch, and a digital-to-analog (D/A) converter, and the second switching module is serially connected between the D/A converter and the buffer;
the control circuit is used for simultaneously outputting a signal for controlling turn-off of the buffer, a signal for controlling turn-off of a switch in the second switching module, and a signal for controlling turn-off of the gamma reference voltage circuit;
the control circuit is used for outputting a signal for controlling turn-on of a switch in the first switching module, so as to implement short connection between two adjacent pixels in the pixel array; and the control circuit is used for outputting a signal for controlling the row driving circuit, so as to implement charging of an i^{th} row pixel storage capacitor by an (i+1)^{th} row pixel storage capacitor on the same column in the pixel array, wherein i=1, 2, . . . , M−1, and M is the number of rows of the pixels; and
the control circuit is used for simultaneously outputting a signal for controlling turn-on of the buffer, a signal for controlling turn-on of the switch in the second switching module, and a signal for controlling turn-on of the gamma reference voltage circuit, so as to implement charging of the storage capacitors in the pixel matrix by the column driving circuit.

2. The charge sharing system of an LCoS display according to claim 1, wherein when the column driving circuit does not charge the storage capacitors in the pixel matrix, the control circuit sends a signal for controlling turn-off of the buffer and the gamma reference voltage circuit.

3. A charge sharing method of a liquid crystal on silicon (LCoS) display, comprising:
(1) a control circuit simultaneously outputting a signal for controlling turn-off of a buffer, a signal for controlling turn-off of a switch in a second switching module, and a signal for controlling turn-off of a gamma reference voltage circuit;
(2) after an i^{th} row scanning signal arrives, the control circuit outputting a signal for controlling turn-on of a switch in a first switching module, so as to implement short connection between two adjacent pixels on the same row in the pixel array, wherein i=1, 2, . . . , M−1, and M is the number of rows of the pixels;
(3) after the short connection between the two adjacent pixels on the same row in the pixel array is implemented, the switch in the first switching module being turned off, and the control circuit outputting a signal for controlling a row driving circuit, so as to implement charging of an i^{th} row pixel storage capacitor by an (i+1)^{th} row pixel storage capacitor on the same column in the pixel array; and
(4) the control circuit simultaneously outputting a signal for controlling turn-on of the buffer, a signal for controlling turn-on of the switch in the second switching module, and a signal for controlling turn-on of the gamma reference voltage circuit, so as to implement charging of the i^{th} row storage capacitor in the pixel matrix by the column driving circuit, wherein when all the pixel storage capacitors in the pixel matrix are charged, the process ends; otherwise, Steps (1) to (4) are repeated.

4. The charge sharing method of an LCoS display according to claim 3, wherein the control circuit outputting the signal for controlling the row driving circuit, so as to implement the charging of the i^{th} row pixel storage capacitor by the (i+1)^{th} row pixel storage capacitor on the same column in the pixel array in Step (3) specifically comprises:
the control circuit outputting a signal for controlling the row driving circuit, and loading a scanning pulse to (i+1)^{th} row pixels, so as to implement short connection between row, the pixel storage capacitors on the same column of the i^{th} row and the (i+1)^{th} row, so as to implement the charging of the i^{th} row pixel storage capacitor by the (i+1)^{th} row pixel storage capacitor on the same column.
